(19) United States
(12) Patent Application Publication
(10) Pub. No.: US 2009/0035042 A1
(43) Pub. Date: Feb. 5, 2009

(54) PRINTING DEVICE AND PRINTING METHOD THEREOF

(75) Inventors: UI-CHOON LEE, Suwon-si (KR); Hyou-jin Kim, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/055,636

(22) Filed: Mar. 26, 2008

(30) Foreign Application Priority Data
Jul. 31, 2007 (KR) 2007-76942

(51) Int. Cl. B41J 21/17

(52) U.S. Cl. 400/70

(57) ABSTRACT

A printing device that includes: a printing unit that performs double-sided printing on special paper; and a control unit that controls the printing unit to print one side of the special paper at a first printing rate, and to print the other side of the special paper at a different second printing rate. Accordingly, an overall printing rate is faster than a conventional printing device, a fixing quality is maintained, and printing performance is improved. The printing device can include a interface unit or a UI unit, to set the first and second printing rates.

### CROSS-REFERENCE TO RELATED APPLICATION

This application claims the benefit of Korean Application No. 2007-76942, filed Jul. 31, 2007, in the Korean Intellectual Property Office, the disclosure of which is incorporated herein by reference.

### BACKGROUND OF THE INVENTION

1. Field of the Invention

Aspects of the present invention relate to a printing device and a printing method thereof, and more particularly, to a printing device that uses different printing rates on each side of a sheet of paper, and a printing method thereof.

2. Description of the Related Art

Conventionally, only one side of a page was printed. Printing devices capable of performing double-sided printing have been developed, due to advances in printing technology and the demands of users.

FIG. 1 is a cross-sectional view of a conventional printing device (laser printer), which can perform double-sided printing. As shown in FIG. 1, a main body 10 of the laser printer includes a printing path 9 where an image is printed on a sheet of paper, a discharging path 16 to discharge the printed paper, and a reverse path 20 to reverse a direction of the paper, to perform the double-sided printing.

A pick-up roller 12, a feeding roller 13, and printing units 14, 15, 18, and 19 are installed above the printing path 9. The pick-up roller 12 picks up paper from a paper feeding cassette 11, and the feeding roller 13 feeds the picked-up paper to the printing units 14, 15, 18, and 19. The printing units 14, 15, 18, and 19 may be various elements, according to the type of printer. A laser printer may include, for example, a laser scan unit 14, a developing roller 18, a photoconductive drum 19, and a fixing roller 15.

At the end of the discharging path 16, a discharging roller 17 is mounted to discharge paper, and to reverse the driving direction, according to the control of a control unit (not shown), so paper is either discharged, or turned back along the reverse path 20. Pairs of transfer rollers 22 are disposed on the reverse path 20, to guide paper to the feeding roller 13.

The conventional printing device is operated as follows. If the printing device is set for double-sided printing, and print data is input from a user terminal, the rollers 22 and the printing units 14, 15, 18, and 19 are operated. Paper is picked up by the pick-up roller 12, and transferred to the printing units 14, 15, 18, and 19, by the feeding roller 13. An image is developed on one side of the paper, by the photoconductive drum 19 and the developing roller 18, and is fixed to the paper by the fixing roller 15. Subsequently, part of the paper is discharged by the discharging roller 17, and then the direction of rotation of the discharging roller 17 is reversed, so the paper enters the reverse path 20.

The paper entering the reverse path 20 is transferred to the feeding roller 13, by the transfer roller 22, and then to the printing units 14, 15, 18, and 19, so that an image is developed and fixed on the other side of the paper. Finally, the paper is externally discharged, by the discharging roller 17.

Conventionally, in such double-sided printing, standard paper and special paper are not printed separately. Special paper refers to paper which is thicker than standard paper, or is formed of a special material. When standard paper sizes, such as, A4, or B4 paper, is printed double-sided, there are no problems with the fixing quality. However, when the special is printed double-sided, difficulties can arise in fixing the toner.

When the special paper is printed double-sided, printing rates for both the front and back of the paper are reduced, in a conventional printer. As a result, an overall printing rate is reduced, as compared to an overall printing rate for the standard paper.

### SUMMARY OF THE INVENTION

Aspects of the present invention relate to a printing device that prints each side of special paper at different printing rates, so that the overall printing rate is faster than in a conventional printing device, and fixing quality is improved, resulting in better performance and printing quality, and a printing method thereof.

Additional aspects of the present invention relate to a printing device and a printing method thereof, wherein a user can set different printing rates for each side of a sheet of paper, so that the user interface is improved.

According to an aspect of the present invention, there is provided a printing device including a printing unit that performs double-sided printing on special paper, and a control unit that operates the printing unit, to print one side of the special paper at a first printing rate, and to print the other side of the special paper at a different second printing rate.

According to aspects of the present invention, the printing device includes a determination unit that determines whether paper provided to the printing unit is special paper, and notifies the control unit of the determination result.

According to aspects of the present invention, the determination unit comprises a sensor to determine the paper type, or identifies the paper type by referring to a user input paper type.

According to aspects of the present invention, the printing device further includes a user interface (UI) unit, which receives a command to perform double-sided printing.

According to aspects of the present invention, the UI unit displays a UI to set at least one of the first printing rate and the second printing rate, if the command to perform double-sided printing on the special paper is input.

According to aspects of the present invention, the printing device includes an interface unit, which is connected to a host device, and a control unit to control the double-sided printing on the special paper, according to a command received through the interface unit.

According to aspects of the present invention, the printing device includes a user interface (UI) unit, which receives a command to perform double-sided printing on the special paper.

According to aspects of the present invention, the UI unit displays a UI to set at least one of the first and second printing rates, when the command to perform double-sided printing on the special paper is input, and the control unit controls the printing unit to print on the special paper, according to the first and/or second printing rates set through the displayed UI.

According to aspects of the present invention, the special paper comprises cotton-based paper, paper having stickers on one side, and paper thicker than standard paper.

According to aspects of the present invention, the control unit drives the printing device at the first printing rate and at the second printing rate, by controlling the rotation rate of a driving roller, which transfers paper in the printing unit.

According to another aspect of the present invention, a double-sided printing method of a printing device includes: receiving a command to perform double-sided printing on special paper; printing one side of the special paper at a first printing rate, and printing the other side of the special paper at a different second printing rate, according to the command.

According to aspects of the present invention, the method further includes determining whether paper provided to the printing unit is special paper, by using a sensor to sense the paper type, or by detecting a paper type input by a user.

According to aspects of the present invention, the command to perform double-sided printing on the special paper is input from a host device, or a user interface (UI) of the printing device.

According to aspects of the present invention, the method includes displaying an UI to set at least one of the first printing rate and the second printing rate, when the command to perform double-sided printing on the special paper is input.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a conventional printing device having a double-sided printing function;

FIG. 2 is a block diagram of the structure of a printing device, according to an exemplary embodiment of the present invention;

FIG. 3 is a block diagram of the structure of a printing device, according to an exemplary embodiment of the present invention;

FIG. 4 illustrates an example of a display screen, according to various embodiments of the present invention;

FIG. 5 illustrates an example of special paper including labels on the front thereof;

FIG. 6 is a flow chart of a printing method, according to an exemplary embodiment of the present invention;

FIG. 7 is a detailed flow chart of a printing method, according to an exemplary embodiment of the present invention; and

FIG. 8 is a flow chart of a printing method, according to another exemplary embodiment of the present invention.

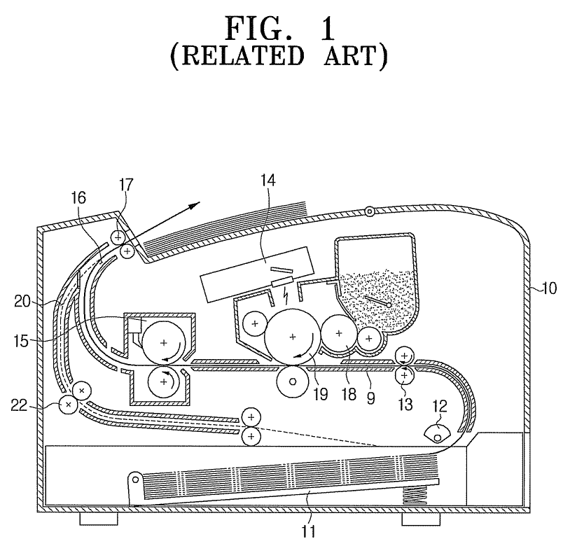

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

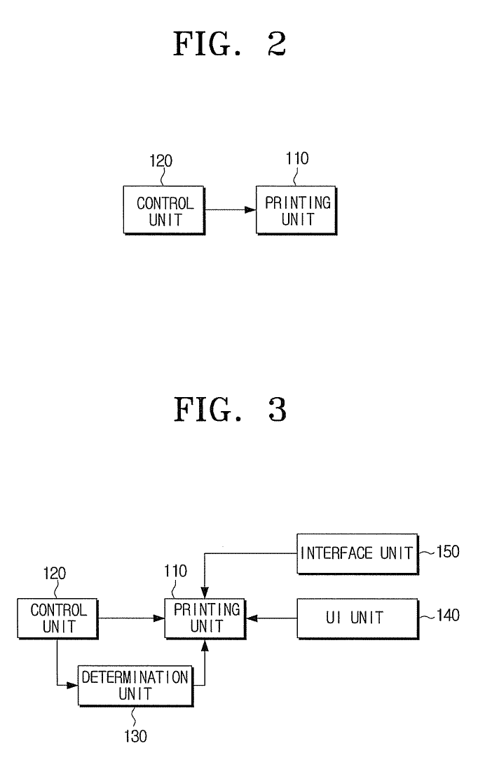

FIG. 2 is a block diagram of the structure of a printing device, according to a first exemplary embodiment of the present invention. With reference to FIG. 2, the printing device includes a printing unit 110 and a control unit 120. The printing unit 110 performs double-sided printing on special paper.

The control unit 120 controls the printing unit 110 to carry out printing. If double-sided printing on special paper is started, the control unit 120 controls the printing unit 110, so that one side of the special paper is printed at a first printing rate, and the other side of the special paper is printed at a different second printing rate. The control unit 120 controls the first and second printing rates, by adjusting the rotation rates of driving rollers in the printing unit 110, which transfer the paper. That is, the rotation rates of the driving rollers are adjusted by controlling a driving motor (not shown). Therefore, an overall printing rate of the printing device is adjusted by the control unit 120.

As referred to herein, the special paper can be paper that is not generally used. The special paper may not have a standard size, such as, A4 and B4. The special paper includes paper which has a specially processed surface, paper having stickers attached to a surface thereof, paper having a glossy surface, paper that is thicker than standard paper, paper made from cotton or linen, such as, letterhead paper, resume paper, and the like.

FIG. 3 is a block diagram of the structure of a printing device, according to various embodiments of the present invention. As shown in FIG. 3, the printing device includes a determination unit 130, a user interface (UI) unit 140, an interface unit 150, a printing unit 110, and a control unit 120. Various exemplary embodiments may add or omit different elements, according to particular applications. According to some exemplary embodiments, the printing device may include the determination unit 130, the printing unit 110, and the control unit 120.

The determination unit 130 determines whether paper in the printing device is special paper, and notifies the control unit 120 of the determination. The determination unit 130 may comprise a sensor to detect the type of paper. In more detail, the determination unit 130 detects the special paper, by measuring the resistance of the paper, the thickness of the paper, and/or a material of the paper.

Alternatively, the determination unit 130 may comprise a photo coupler to determine whether the paper is special paper, by measuring the optical reflection rate, or the optical penetration rate, of the surface of the paper. Furthermore, the determination unit 130 may determine whether or not paper is special paper, by detecting a paper type input by a user through the UI unit 140 and/or the interface unit 150. The determination unit 130 may determine whether or not the paper is special paper using any suitable method or detection device.

If the determination unit 130 determines that the paper is special paper, the control unit 120 carries out double-sided printing, with different printing rates for each side of the special paper. If the special paper has a specially processed surface, for example, paper with stickers or labels attached to one side, letterhead paper, or paper having a glossy surface, the specially processed surface is printed at a slower printing rate, but the other side having a normal surface is printed at a normal printing rate.

In another exemplary embodiment, the printing device includes the determination unit 130, and the UI unit 140. In this case, if a double-sided printing command is input through the UI unit 140, the control unit 120 controls the determination unit 130, to determine whether the paper is special paper. If the paper is special paper, double-sided printing is performed on the special paper, as described above.

If the paper is special paper, the control unit 120 receives one or more printing rates set through the UI unit 140. In other words, if double-sided printing on the special paper is started, the UI unit 140 provides the user with a UI, to set printing rates for each side of the special paper, so the user can select a first printing rate and/or a second printing rate. The first printing rate can be applied to a side of the special paper, which has a specially processed surface. The first printing rate can be set to a slower rate than the normal printing rate, for example, ½, or ⅔ of the normal printing rate. The second printing rate can be applied to the other side, which has a normal surface. The second printing rate can be set to the normal printing rate. If both sides have special surfaces, the first and second printing rates may be set to a slower rate than the normal printing rate.

According to another exemplary embodiment of the present invention, the printing device includes the UI unit 140, the printing unit 110, and the control unit 120. The UI unit 140 may provide a UI showing a “double-sided printing on special paper” menu, as well as a “double-sided printing” menu. If the “double-sided printing on special paper” menu is selected, the control unit 120 may perform double-sided printing, by applying the first and second printing rates, as described above.

If the “double-sided printing on special paper” menu is selected, the UI unit 140 may additionally provide a UI for the user to set the first and second printing rates. Subsequently, the control unit 120 can perform double-sided printing, by applying the user set printing rates.

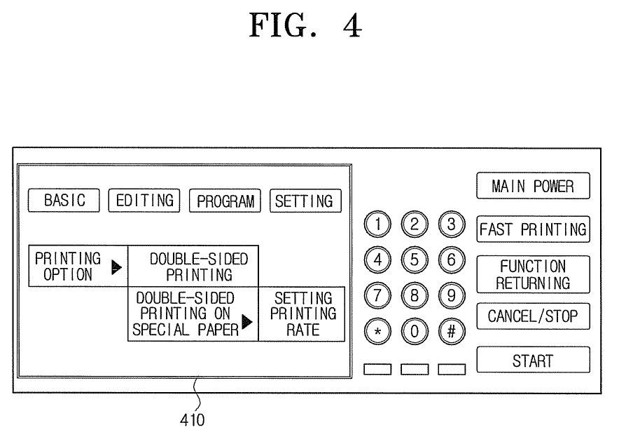

FIG. 4 illustrates an example of a screen of a display unit 410, according to an exemplary embodiment of the present invention. The UI unit 140 controls the display unit 410, to show the “double-sided printing” menu and the “double-sided printing on special paper” menu. If the “double-sided printing on special paper” menu is selected, a printing rate setting menu is displayed at a side thereof, as shown in FIG. 4. Subsequently, the control unit 120 performs the operation, according to the rate set by the user, using the selected menu.

According to another exemplary embodiment of the present invention, a command to perform double-sided printing on special paper may be received from a host device (not shown). The printing device of FIG. 3 may include the interface unit 150, the printing unit 110, and the control unit 120. The interface unit 150 is connected to the host device locally, or through a network, according to a selected communication interface. Accordingly, the user may execute a printer driver program installed in the host device, set the printing options, and set print the data. The user can thereby set an option to perform double-sided printing on special paper.

A printing command, according to the set option, is transmitted to the control unit 120, through the interface unit 150. If the control unit 120 determines that the option to perform double-sided printing on special paper are set, double-sided printing on special paper is performed at the first and second printing rates, as described above. In this case, if the printing device further comprises the UI unit 140, the control unit 120 can directly receive the printing rate settings, through the UI unit 140.

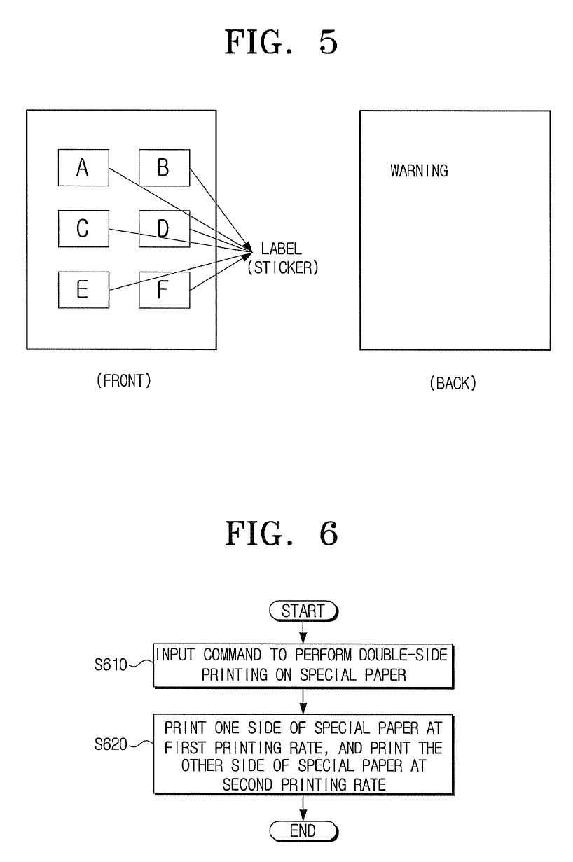

FIG. 5 illustrates an example of the special paper, which has labels. With reference to FIG. 5, labels are attached to the front of the special paper. On the back of the special paper, “warning” is written.

If printing is performed on the special paper, it is difficult to fix toner to the labels. Therefore, the front of the paper is printed at a slower printing rate than the normal printing rate. In more detail, the front is printed by receiving a printing command from the user using the UI unit 140, or the interface unit 150, and the printing rate for the front is set to be a slower rate than the normal printing rate. The back of the paper is printed at the normal printing rate, which can be preset. In contrast, if double-sided printing is performed on special paper having labels on the back and a normal surface on the front, the front is printed at the normal printing rate and the back at the slower printing rate, using the UI unit 140 or the interface unit 150.

When the special paper is higher quality paper, such as, paper including cotton and/or linen. Such paper has a low fixing quality, when printed by conventional printing methods. According to aspects of the present invention, double sided printing is performed at a slower printing rate than the normal printing rate, so the special paper may have a higher fixing quality. That is, when double-sided printing is performed on such special paper, the front is printed at the normal printing rate, and the back is printed at a slower printing rate. In double-sided printing, an image on front of the special paper passes through the fixing unit twice, so the front can be printed at the normal printing rate, without experiencing fixing/print quality problems.

The normal printing rate and the slower printing rate may be expressed as the first printing rate and the second printing rate, and vice versa. The slower printing rate can vary according to user convenience, and may be, for example, ½ or ⅔ of the normal printing rate, in order to enhance fixing quality.

FIG. 6 is a flow chart explaining a printing method, according to an exemplary embodiment of the present invention. With reference to FIG. 6, a command to perform double-sided printing on special paper is received, in operation S610. In operation S620, one side of the special paper is printed at a first printing rate, and the other side is printed at a second printing rate, according to the received command.

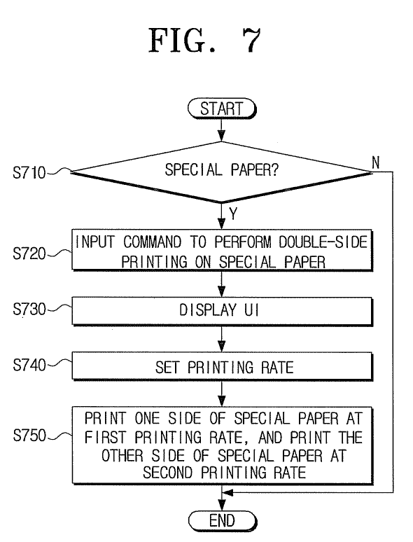

FIG. 7 is a detailed flow chart explaining an exemplary printing method. With reference to FIG. 7, whether paper is special paper is determined by using a sensor, or by identifying a user input paper type, in operation S710.

In operation S720, if the paper is special paper, a command to perform double-sided printing on the special paper is input. In operation S730, a UI to set at least one of the first printing rate and the second printing rate, is displayed.

In operation S740, at least one of the first printing rate and the second printing rate is set, using the UI. A first mode, in which the first printing rate is the normal printing rate, and the second printing rate is a slower preset printing rate, may be set. Alternatively, a second mode, in which the first printing rate is the slower preset printing rate, and the second printing rate is the normal printing rate, may be set. If the first or second mode is set, one side of the special paper is printed at the first printing rate, and the other is printed at the second printing rate, in operation S750.

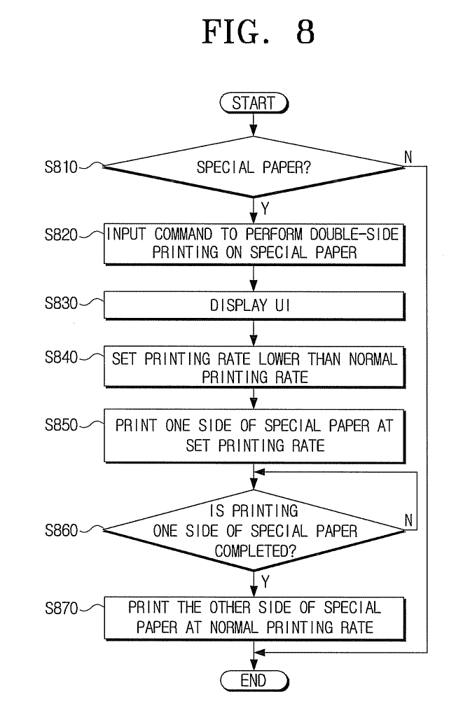

FIG. 8 is a flow chart explaining a printing method, according to the second exemplary embodiment of the present invention. More specifically, FIG. 8 illustrates a printing method that may be used when labels are attached to the front of the special paper, or when the special paper is high quality paper.

In operation S810, whether or not the paper is special paper is determined. In operation S820, if the paper is special paper, a command to perform double-sided printing on the special paper is input. In operation S830, a UI to set at least one of the first printing rate and the second printing rate, is displayed.

In operation S840, a first printing rate to print the front of the special paper, is set using the UI. In operation S850, the front is printed. The first printing rate is a slower printing rate than a normal printing rate.

In operation S860, whether the printing on the front of the paper is completed, is determined, using the printing path. If the printing the front of the paper is completed, the back of the paper is printed at the normal printing rate, in operation S870.

As can be appreciated from the above description, double-sided printing may be performed, so that one side of paper is printed at a slower printing rate than a normal printing rate, so that the overall printing rate is faster than in a conventional printing device. Fixing quality is maintained, resulting in better performance and printing quality.

The printing rates can be adjusted, by receiving a command to set the printing rate, using the interface unit or the UI unit, so that user convenience is improved.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A printing device comprising:
a printing unit to perform double-sided printing on special paper; and
a control unit to control the printing unit to print a first side of the special paper at a first printing rate, and to print a second side of the special paper at a second printing rate that is different from the first printing rate.

2. The printing device of claim 1, further comprising a determination unit to determine whether paper provided to the printing unit is the special paper, and to notify the control unit of the determination.

3. The printing device of claim 2, wherein the determination unit comprises a sensor to determine whether the special paper is provided.

4. The printing device of claim 2, further comprising a user interface (UI) unit to receive a command to perform the double-sided printing.

5. The printing device of claim 4, wherein the UI unit displays a UI to set at least one of the first printing rate and the second printing rate.

6. The printing device of claim 1, further comprising an interface unit connected to a host device,
wherein the control unit performs the double-sided printing, according to a command received through the interface unit.

7. The printing device of claim 1, further comprising a user interface (UI) unit to receive a command to perform the double-sided printing.

8. The printing device of claim 7, wherein the UI unit displays a UI to set at least one of the first and second printing rates, when the command to perform double-sided printing is input,
wherein the control unit controls the printing unit to print the special paper according to the set at least one first and second printing rate.

9. The printing device of claim 1, wherein the special paper is selected from the group consisting of: paper comprising cotton; paper comprising linen; paper having stickers applied thereto; paper having a glossy surface; paper that is thicker than standard paper, or a combination thereof.

10. The printing device of claim 1, wherein the control unit drives the printing device at the first printing rate and the second printing rate, by controlling the rotation rate of a driving roller that transfers paper in the printing unit.

11. A double-sided printing method of a printing device, the method comprising:
receiving a command to perform double-sided printing on special paper; and
printing a first side of the special paper at a first printing rate, and printing a second side of the special paper at a second printing rate that is different from the first printing rate, according to the command.

12. The method of claim 11, further comprising using a sensor to determine whether paper provided to the printing unit is the special paper.

13. The method of claim 11, wherein, the command is input from a host device, or from a user interface (UI) of the printing device.

14. The method of claim 11, further comprising displaying an UI to set at least one of the first and second printing rates.

15. The method of claim 11, wherein the special paper is selected from the group consisting of: paper comprising cotton; paper comprising linen; paper having stickers applied thereto; paper having a glossy surface; paper that is thicker than standard paper, or a combination thereof.

16. The printing device of claim 2, wherein the determination unit determines whether the special paper is provided, by referring to paper type input by a user.

17. The method of claim 11, further comprising determining whether the special paper is provided to the printing unit, by referring to a paper type input by a user.

18. A printing device comprising:
a printing unit to print on first and second sides of special paper; and
a control unit to control the printing unit to print the first side of the special paper at a first printing rate, and then to print the second side of the special paper at a second printing rate that is different from the first printing rate,
wherein the special paper comprises cotton, linen, stickers applied thereto, a glossy surface treatment, a thickness that is greater than standard paper, or a combination thereof.

19. The printing device of claim 1, further comprising a determination unit to determine whether the special paper is provided to the printing unit, and to notify the control unit of the determination.

20. The printing device of claim 18, further comprising a user interface (UI) unit to display a UI, through which a user sets at least one of the first printing rate and the second printing rates.

21. A method of double sided printing on special paper using a printing apparatus, the method comprising:
printing a first side of the special paper at a first printing rate; and
printing a second side of the special paper at a second printing rate that is different from the first printing rate,
wherein the special paper comprises cotton, linen, stickers applied thereto, a glossy surface, a thickness that is greater than standard paper, or a combination thereof.

22. The method of claim 21, further comprising using a sensor to determine whether paper provided to the printing unit is the special paper.

23. The method of claim 21, wherein the first printing rate is slower than the second printing rate, if first side of the special paper comprises the stickers, the glossy surface, or a combination thereof.

24. The method of claim 21, wherein the first printing rate is faster than the second printing rate, if first side of the special paper is substantially the same as the second side of the special paper.

25. The method of claim 21, further comprising:
displaying an user interface; and
setting the first and second printing rates through the user interface.
